(19) United States
(12) Patent Application Publication
(10) Pub. No.: US 2003/0156888 A1
(43) Pub. Date: Aug. 21, 2003

(54) Device for fixing a subassembly to an essentially smooth driveshaft

(76) Inventor: Frank Kopf, Ottersweier (DE)

Correspondence Address: Striker Striker & Stenby, 103 East Neck Road, Huntington, NY, 11743, US

(21) Appl. No.: 10/009,224

(22) PCT Filed: Jan. 10, 2001
(86) PCT No.: PCT/DE01/00058

(30) Foreign Application Priority Data
Mar. 18, 2000 (DE) 100 13 609.5

(51) Int. Cl. F16D 1/06

(52) U.S. Cl. 403/1

(57) ABSTRACT

The invention relates to a device for securing an add-on part (10) to a substantially smooth drive shaft (12), comprising a slaving element (14), which is seated in a manner fixed against relative rotation on the drive shaft (12) and transmits a rotary motion from the drive shaft (12) to the add-on part (10), and further comprising a spring element (16), which axially secures the add-on part (10) on the drive shaft (12).

It is proposed that the slaving element (14) penetrates the add-on part (10), and the spring element (16) is braced on the one hand on the slaving element (14) and on the other on the add-on part (10) and thus axially fixes the add-on part (10).

### PRIOR ART

The invention is based on a device for securing add-on parts to a drive shaft as generically defined by the preamble to the independent claim.

In known devices of this kind, the add-on parts, such as tools or fans, are driven by motors via a shaft. In plastic add-on parts, for this purpose a slaving element is mounted with positive engagement relative to the add-on part on the drive shaft. The counterpart contour of the slaving element is located on the add-on part to be driven, so that a slaving action in the direction of rotation of the drive shaft is attained. The axial fixation of the add-on part on the drive shaft is done by means of a spring element, which is clamped between the add-on part and a groove that is made in the drive shaft.

When smooth drive shafts are used, the axial fixation of the add-on part to the slaving element has until now been done by screwing the add-on part to the slaving element. Screw connections are time-consuming, however, and therefore very expensive in terms of production. Furthermore, screw connections require a complicated slaving element construction.

German Utility Model DE-GM 92050972 describes a fan, which for securing the fan wheel in the axial direction uses a spring element with five hooklike arms, which reach through the hub of the fan wheel and cooperate with portions of the slaving element. Spring elements of this type, which use a plurality of spring arms to secure the add-on part to the slaving element of the drive shaft, require skillful assembly, including complicatedly checking that the mounted seating is correct. This means increased expenditure of time and money.

### ADVANTAGES OF THE INVENTION

The device according to the invention for securing an add-on part to a substantially smooth shaft, having the characteristics of claim 1, has the advantages that it enables fast, simple mounting of arbitrary add-on parts on a smooth drive shaft using a simple spring element.

Since the slaving element penetrates the add-on part, axially securing the add-on part to the drive shaft can be performed by a simple spring element, and thus not only production-dictated tolerances but play occurring over the course of time can be compensated for. The spring element can be produced easily and economically, is secured when mounted, and can be used in industrial mass production. Complicated, vulnerable multi-armed spring elements are no longer necessary. Time-consuming screw fastenings of the add-on part to the slaving element can be dispensed with entirely. Since the securing spring element is braced directly on the slaving element of the drive shaft and acts on the add-on part, the drive shaft need not be prepared by means of additional machining steps. This makes a simple, cost-saving production of the drive shafts possible as well.

By means of the provisions recited in the dependent claims, advantageous refinements and improvements to the device defined by claim 1 are possible.

In the device of the invention, the add-on part is clamped between the spring element and one portion of the slaving element. In the process, the add-on part comes to rest stably on a platelike widening of the slaving element. The slaving element is shaped such that the spring element itself can in turn be braced on a part of the slaving element. Thus the spring element is seated between two sides of the slaving element, and an additional groove in the shaft for securing the spring element is for instance no longer necessary.

An add-on part with appropriate recesses can easily be slipped onto the slaving element of the drive shaft. By means of the simple axial spring securing, fast mounting is assured, and the add-on part can also be replaced easily. The spring element itself can be secured easily against slipping and twisting on the add-on part. As the spring element, a simple one-piece spring, such as a standardized, circular cup spring (so-called C-clip) can be used.

The slaving element of the device of the invention is easy to produce in its special embodiment as a shaped part and can optionally also be press-fitted directly onto the drive shaft.

The device of the invention thus unites two functions in its slaving element. First, the slaving element assures the slaving of the add-on part in the direction of rotation of the drive shaft, and second, it enables the axial fixation of the add-on part to the drive shaft by means of a simple spring element.

### DRAWING

In the drawing, one exemplary embodiment of the invention is shown and described in further detail in the ensuing description.

Shown are:

FIG. 1, a cross section of the device of the invention taken along a section line I-I in FIG. 2; and

FIG. 2, an elevation view of the device of the invention in the direction of the arrow II in FIG. 1.

### DESCRIPTION OF THE EXEMPLARY EMBODIMENT

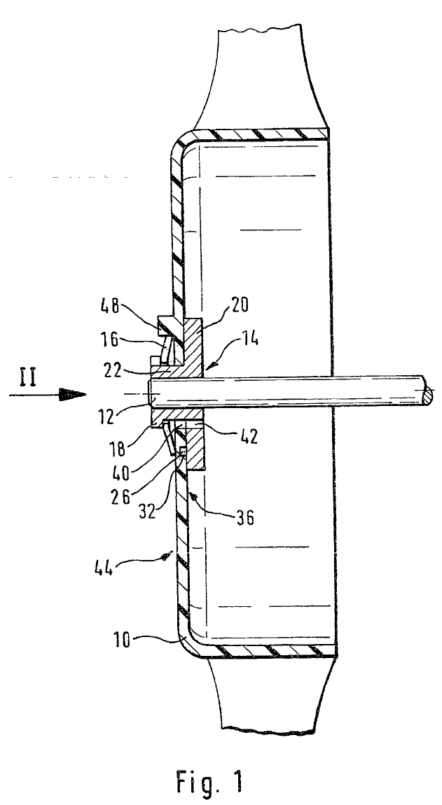

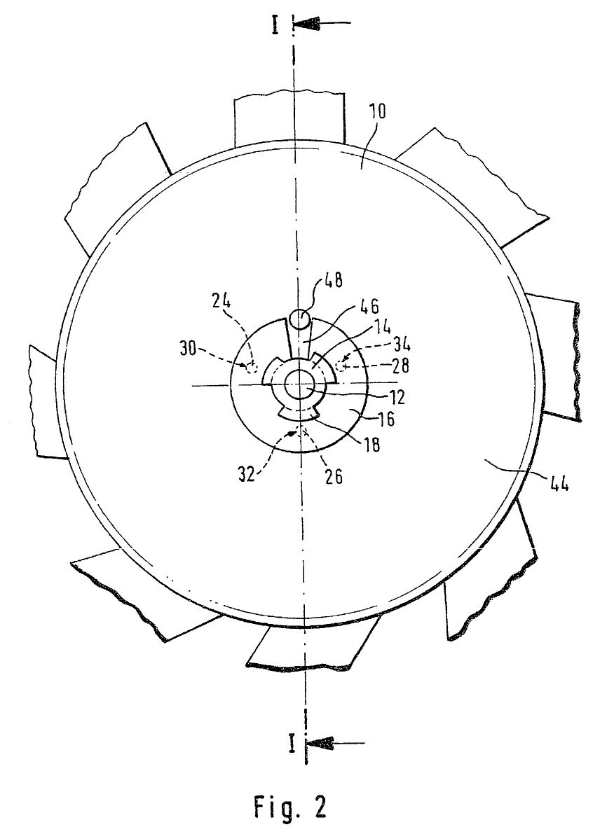

The device, shown in cross section in FIG. 1 and in an elevation view in FIG. 2, for securing an add-on part 10 to a drive shaft 12 essentially comprises a slaving element 14 and a spring element 16. The slaving element 14 is slipped onto the free end—on the right, in FIG. 1—of the drive shaft 12 of a motor, not shown in FIG. 1, and grips this drive shaft 12 by nonpositive engagement and thus in a manner fixed against relative rotation. The spring element 16 axially fixes the add-on part 10 to the slaving element 14 and in this way secures it on the drive shaft 12.

The drive shaft 12 is substantially smooth; that is, except for any residual roughness that may be present, it has no grooves, knurling or other profiling whatever.

The slaving element 14 that grips the drive shaft 12 in a manner fixed against relative rotation has a center piece 22 and two especially shaped ends. On one end—on the right in FIG. 1—the slaving element 14 has a collarlike widening 18, which in the exemplary embodiment is interrupted at three places, as can be seen from the elevation view of the device in FIG. 2. The interruption of the collarlike widening 18 of the slaving element 14 makes it possible from a production standpoint to leave connecting webs between the center piece 22 and the collarlike widening 18 of the slaving element, and thus assures the mechanical stability of the slaving element 14.

On its second end—on the left in FIG. 1—the slaving element 14 of the invention has a platelike widening 20 of its diameter. The connecting center piece 22 is located between these two ends of the slaving element 14. The platelike widening 20 of the slaving element 14 has recesses 42, corresponding in position and number to the multiply interrupted collarlike widening 18. Through these recesses 42, half of a tool can be passed, in the production of the slaving element 14 by the shaping process, in order to shape the underside of the collarlike widening 18.

In accordance with the segmentation existing in the exemplary embodiment of the collarlike widening 18 of the slaving element 14, the add-on part 10 has three recesses 40, only one of which can be seen in FIG. 1. Through these recesses 40 in the add-on part 10, the slaving element 14 can be passed with its collarlike widening 18, until the add-on part 10 rests on the platelike widening 20 of the slaving element 14.

The add-on part 10 is joined by positive engagement to the center piece 22 of the slaving element 14. The platelike widening 20 of the slaving element 14, on its side toward the add-on part 10, has in this example three pins 24, 26 and 28, of which only pin 26 can be seen in FIG. 1, that are embodied integrally on the slaving element 14 and that fit by positive engagement into aligned bores 30, 32 and 34 on the inside 36 of the add-on part 10 and thus transmit the rotary motion of the slaving element 14 to the add-on part 10.

A circular spring element 16 open on one side, in the form of a frustoconical cup spring, embraces the center piece 22 of the slaving element 14, which piece projects through the add-on part 10, and in the process is braced on the one hand on the underside of the collarlike widening 18 of the slaving element 14. On the other, the spring element 16 is braced on the outside 44 of the add-on part 10 resting on the platelike widening 20 of the slaving element 14.

In this way, the add-on part 10 is clamped firmly between the two widenings 18 and 20 on the ends of the slaving element 14 and is thus fixed in the axial direction on the slaving element 14 and thus simultaneously secured on the drive shaft 12.

The spring element 16 for axially securing the add-on part 10 to the slaving element 14 has a spring gap 46. This spring gap 46, in the securing of the add-on part 10 to the slaving element 14, is placed above a positioning pin 48, which is formed on the outside 44 of the add-on part 10. Because of this positioning pin 48, the spring element 16 cannot twist substantially counter to the add-on part 10 and the slaving element 14. The positioning pin 48 thus prevents the spring gap 46 from coming to rest under one segment of the collarlike widening 18 of the slaving element 14, in which case the spring element 16 would no longer be fastened uniformly under the collarlike widening 18 of the slaving element 14. Furthermore, imbalances that could be caused by the asymmetrical spring element 16 can thus be compensated for.

The invention is not limited to the exemplary embodiment described:

For instance, the slaving element 14 can be press-fitted directly onto the drive shaft 12 of the motor.

Nor is the device of the invention limited to the use of a circular cup spring open on one side.

Nor is the transmission of the rotary motion of the slaving element 14 to the add-on part 10 limited to the method described in the exemplary embodiment. For instance, the rotational slaving could be achieved by means of a structure (such as a web)—formed directly on the center piece 22 of the slaving element 14—if the thus-shaped center piece 22 can be passed through the recesses 40—which are three in number in the example presented—in the add-on part 10. This web then engages a corresponding counterpart structure in the add-on part 10, such as a groove, in such a way that the slaving element 14 has positive engagement with the add-on part 10 in the circumferential direction.

1. A device for securing an add-on part (10) to a substantially smooth drive shaft (12), having a slaving element (14), which is seated in a manner fixed against relative rotation on the drive shaft (12) and transmits a rotary motion from the drive shaft (12) to the add-on part (10), and having a spring element (16), which axially secures the add-on part (10) on the drive shaft (12), characterized in that the slaving element (14) penetrates the add-on part (10), and the spring element (16) is braced on the one hand on the slaving element (14) and on the other on the add-on part (10) and thus axially fixes the add-on part (10).

2. The device of claim 1, characterized in that the add-on part (10) is clamped between the spring element (16) and a portion of the slaving element (14).

3. The device of one of claims 1 or 2, characterized in that the spring element (16) is embodied in one piece.

4. The device of one of claims 1-3, characterized in that the slaving element (14) has a collarlike widening (18), on which the spring element (16) is braced.

5. The device of claim 4, characterized in that the add-on part (10) has recesses (40), through which the slaving element (14) can be passed with its collarlike widening (18).

6. The device of one of claims 1-5, characterized in that the add-on part (10) has positive engagement with the slaving element (10) and in particular embraces it by positive engagement.

7. The device of one of claims 1-6, characterized in that the slaving element (14) has a platelike widening (20) of its diameter, at which the add-on part (10) is braced.

8. The device of claim 7, characterized in that in the platelike widening (20), the slaving element (14) has recesses (42) corresponding to the location of the collarlike widening (18).

9. The device of one of the foregoing claims, characterized in that the spring element (16) is a circular cup spring (C-clip) that is open on one side.

10. The device of one of claims 1-9, characterized in that the spring element (16) is secured on the add-on part (10) against later twisting by means of a positioning pin (48).

11. The device of one of the foregoing claims, characterized in that the add-on part (10) to be secured is a vane wheel of a fan.

12. The device of one of the foregoing claims, characterized in that the slaving element (14) is press-fitted onto the drive shaft (12).
